(19) United States
(12) Patent Application Publication
(10) Pub. No.: US 2009/0230584 A1
(43) Pub. Date: Sep. 17, 2009

(54) Method for extruding foam plastic frame members

(76) Inventors: Ronald F. Edger, Woodbridge (CA); Stephen H. Shultis, Woodbridge (CA); Felice Lamanna, Woodbridge (CA); Fortunato Bordin, Woodbridge (CA); Matthew Gentile, Woodbridge (CA)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/472,686

(22) Filed: May 27, 2009

Related U.S. Application Data
(62) Division of application No. 10/962,407, filed on Oct. 13, 2004.

(30) Foreign Application Priority Data
Oct. 15, 2003 (CA) 2,445,094

(51) Int. Cl. B29C 47/06

(52) U.S. Cl. 264/173.16

(57) ABSTRACT

Elongated frame members are provided having rigid framed plastic cores with smooth hard outer skins and separately coextruded plastic coatings covering separately selected areas of the skin. The members may also be hollow. The invention further involves the method and tooling for making same.

### CROSS-REFERENCE TO RELATED APPLICATIONS

This application is a division of U.S. patent application Ser. No. 10/962,407, filed Oct. 13, 2004, which is relied on and incorporated herein by reference.

### FIELD OF THE INVENTION

This invention is directed to elongated extruded plastic members having profiles for use in forming frames including particularly window and door frames and, more particularly, to such members having foamed plastic bodies or cores with smooth hard enveloping outer skins and with separately coextruded coatings on selected surface areas of said outer skins. The invention is particularly directed to such members in which the cores are hollowed to have at least one internal closed chamber running the length thereof.

The invention further relates to the method and tooling for producing such members.

### BACKGROUND OF THE INVENTION

The use of wood in forming frames such as window and door frames has been greatly replaced by frames formed from extruded members and, in particular, extruded rigid plastic members whose desired profiles can be accurately produced without requiring the meticulous work needed to provide a detailed wood frame profile and whose weatherability and insulating properties are vastly superior to those of wood. Moreover, such plastic members are free from other problems encountered with wood such as splintering, rotting and destruction by insects.

While frame members of metal such as aluminum and steel have often been used, such frame members lack the insulation qualities of plastic frames and they have their own particular problems being subject to corrosion and rust and requiring quite considerable maintenance.

With respect to extruded plastic frames, U.S. Pat. Nos. 5,406,768 and 5,497,594 disclose the production of an extruded wood fiber reinforced thermoplastic frame members for use in framing doors and windows. These members are not foamed and comprise a hollow cross section having a rigid relatively thick exterior shell or wall with at least one internal support web and one internal fastener anchor. Such members have to be coated, i.e. painted if their applications call for any color other than their natural color.

U.S. Pat. No. 3,216,068 discloses a sealing strip which has a foamed main body having an outer layer of moisture impervious polyvinyl resin fused thereto. However, the main body is formed of a foamed flexible polyvinyl resin and the functioning of this product depends on its ability to deform and then recover which properties are not suitable for frame members which have to be rigid.

U.S. Pat. No. 6,054,207 discloses structural components such as deck planks made from extruded composite foam material comprising from about 90 to 50 wt % of a vinyl polymer and 10 to 50 wt % of wood fiber. Such components, which are relatively expensive, do not themselves have hard smooth surfaces but require a coating or layer of cap stock to provide such desired surfaces and to increase weatherability over and above such purpose additives made to the composite foam material.

U.S. Pat. No. 5,965,075 discloses a triple extrusion method of forming frame members. This method involves the extruding of a plastic foam material to provide the rigid body of the members while coextruding a fluid coating material to at least one surface of the foam material and also coextruding a flange of flexible material bonded to the foam material. The frame members produced by this process have solid cores of foamed plastic with single coextruded coatings.

It is the object of this invention to provide elongated rigid extruded plastic members having precision profiles particularly for use in forming frames which members have superior properties and provide superior performance to existing such members.

It is a further object of the invention to provide such extruded rigid plastic frame members which have thin smooth polished protective enveloping surface skins with selected areas of these surface skins separately coated with separate plastic coatings or cap stocks. According to this aspect of the invention, it is the object to enable selected areas of the surface skins to be coated with coating of different materials and/or different colors and/or different thicknesses.

It is a further object to provide such plastic frame members which are hollow and are relatively light in weight.

It is still a further object to provide such plastic members at relatively low cost.

These and other objects and features of the invention will appear from the following detailed description taken with the accompanying drawings.

### SUMMARY OF THE INVENTION

In its widest aspect the invention resides in providing elongated extruded frame members having desired profiles with cores of foamed plastic preferably foamed PVC, foamed to provide a core enveloping thin tough smooth outer skin, the cores having separately coextruded plastic, preferably PVC, skin coatings on selected areas of their outer skins which coatings may be of the same or different material compositions, and/or the same or different colors, and/or the same or different thicknesses.

In a particularly preferred aspect, the invention resides in providing such frame members with hollowed cores which have at least one hollow chamber running the length thereof.

In another aspect, the invention further resides in providing such frame members in which the profiles have refined details provided by the coatings.

Again, in another aspect, the invention further involves the method and tooling for producing such extruded frame members. In this connection, the method comprises feeding a hot compressed foamable plastic material under pressure through a die having an opening configured to provide the predetermined frame member profile. The die contains a splitter pin to divert the compressed pressure driven hot foamable plastic material outwardly to produce a foamable extrudate flowing under pressure through the space between the periphery of the pin and the perimeter of the die opening. At the same time, a first plastic coating material is delivered through the die onto the outer surface of the foamable extrudate over a first selected area or areas thereof while a second plastic coating material is also delivered through the die onto the outer surface of the foamable extrudate over a second selected area or areas thereof. The hot coated foamable extrudate is then pulled from the die through a calibrating and cooling chamber wherein the outer surface of the hot coated extrudate on contacting the inner peripheral surface of the calibrating and cooling chamber freezes or hardens. This forms a smooth hard thin enveloping core layer or skin from which the extrudate foams inwardly to form the coated skin enveloped foamed core.

In another important aspect of the method of the invention, the calibrating and cooling chamber is provided with at least one cooling pin located therein. This cooling pin has an external configuration corresponding to the desired internal shape of the at least one hollow chamber. As the hot extrudate foams inwardly from the outer skin, it foams around the cooling pin where it hardens to form the hollow chamber.

### BRIEF DESCRIPTION OF THE DRAWINGS

FIG. 1 is a diagrammatic view illustrating the tooling and method of producing foamed frame members having selected surface areas separately coated with selected plastic coatings in accordance with the invention;

FIG. 2 is a broken away exploded perspective view of the tooling represented by the diagrammatic showing of FIG. 1;

FIG. 3 is an exploded perspective view of the components of the die shown in the tooling drawing of FIG. 2;

FIG. 4 is a broken away exploded perspective view illustrating the introduction of the cooling pin into the cooling and calibrating chamber;

FIG. 5 is an end view of the frame profile produced by the tooling illustrated in FIGS. 2 to 4;

FIG. 6 is a broken away perspective view of a more complicated frame profile embodying the invention produced in accordance with the principles of the method of the present invention;

FIGS. 7 and 8 are end views of other frame profiles embodying the invention.

### DETAILED DESCRIPTION ACCORDING TO THE PREFERRED EMBODIMENTS OF THE PRESENT INVENTION

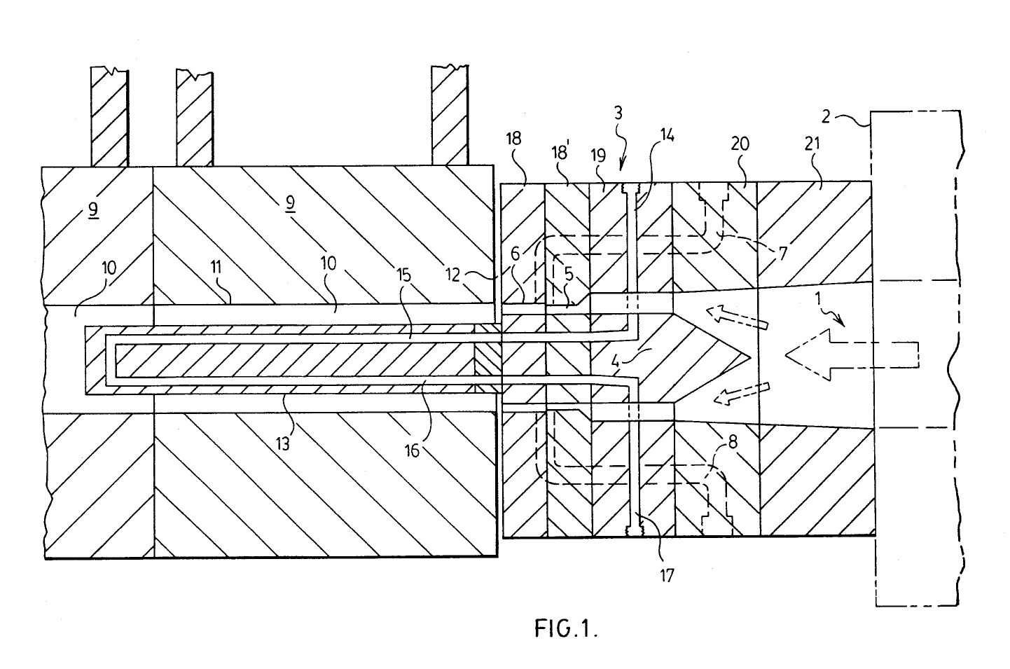

Referring to the schematic drawing FIG. 1, an extrudable hot compressed foamable plastic material or composition 1 is extruded from an extruder 2 into a die generally designated at 3 which contains a torpedo shaped splitter or diverter pin 4 which spreads the hot compressed foamable material 1 around the pin 4 into the space 5 between the perimeter of the pin 4 and the periphery of the die opening 6 which is configured to provide the desired frame member profile.

As this hot compressed foamable extrudate flows through the die, a first plastic coating or cap stock material is delivered to a first selected surface area or areas of the extrudate through passageway 7 through the die to provide a thin plastic coating or cap stock to such first selected extrudate surface area or areas.

A second plastic coating or cap stock material is delivered to a second selected area or areas of a surface of the extrudate through passageway 8 through the die 3 to provide a thin plastic coating or cap stock to such second selected extrudate surface area or areas. Thus, in effect, two cap stocks are separately fed to coat two different selected areas of the surface of the extrudate as the foamable extrudate flows through the die 3 so that these cap stocks are separately coextruded with the foamable extrudate.

The foamable plastic composition 1 is preferably a foamable polyvinyl chloride (PVC) and/or a chlorinated polyvinyl chloride (CPVC) containing the usual process aids, fillers, reinforcing fibrous materials, stabilizers, lubricants and blowing agents such as azodicarbonamide and the like as will be understood by those skilled in the art.

The plastic coating or cap stock materials delivered through passageway 7 and 8 can be any conventional cap stock which is known for this purpose as is well known to those skilled in the art which may be a PVC material, a blend of acrylic and PVC material an acrylic styrene acrylonitrile (ASA) and blends of ASA with polyvinyl chloride. Because these coatings or cap stock materials contain ultra violet stabilizers where their exposure requires same, minimal use of such stabilizers is required in the foamable composition.

As in the conventional extruding process, the hot coated extrudate is pulled from the die by a suitable puller (not shown) through cooling and sizing calibrators 9 whose passageways 10 are configured to match the configuration of the outlet of the die 3.

A thermal break 12 between the die 3 and the first calibrator 9 provides a requisite degree of isolation between the calibrator and the hot die.

In the embodiment shown in FIG. 1, a cooling pin 13 is located within the calibrator's passageway 10. This cooling pin is cooled by circulating cooling water, the water being fed in by a passageway 14 leading in from the periphery of the die 3 through the die, through the splitter pin and thermal break, into the inlet passage 15 of the cooling pin 13 where it circulates through the pin being returned from the outlet passage 16 of the cooling pin to the outlet passage 17 leading through the thermal break and splitter pin and out to the periphery of the die 3 as illustrated.

As the coated foamable extrudate in its hot compressed state is drawn into the passageway 10 of the first calibrator 9, the sudden increase in space between the perimeter of the calibrator opening 10 and the cooling pin 13 allows the highly compressed extrude to expand or foam under the action of the blowing agent or agents. Since the outer surface of the foaming extrudate is in contact with the peripheral wall 11 of the passageway 10 it hardens due to the much lower temperature of this surface whose temperature would be of the order of about 40° F. while the temperature of the extrudate would be of the order of about 380° F. This hardening or “freezing” of the surface of the extrudate forms a thin hard smooth skin enveloping the extrudate which then foams inwardly from this skin to surround the cooling pin 13. This hard outer skin of the foamed plastic forms an isolation barrier which protects the softer material or substrate which it encapsulates from impact damage.

In this connection, it will be noted that the density of the core is greatest at the skin layer against which pressure is exerted as the extrudate foams inwardly. Because of its greater density, the skin contains the greatest concentration of additives including any ultra violet agents incorporated into the foamable compositions.

Of course, added to the protection of the core provided by the enveloping hard skin, including any contained ultra violet agent, are the coextruded cap stocks overlying the areas of this enveloping skin to which they have been applied.

As the layer of foamed plastic which forms the core of the extrusion is a relatively thick layer, it is difficult for this layer to precisely follow the contours of the profile of the calibrator passageway 10. On the other hand, the thin coextruded coatings or cap stock can intimately conform to the wall of the calibrator passageway to provide precision to the details of the profile as well as coating the selected surfaces.

The frame members produced by the invention with their rigid foamed cores with their enveloping hard smooth surfaces and their separately coextruded cap stocks covering selected areas provide highly valuable frame members for framing windows, doors and the like. Such frame members, for example, will have surfaces which will be exposed to the exterior of the building and subjected to all of the weathering elements and, in particular, ultra violet radiation whereas other surfaces of the frame will be exposed to the interior of the building where they will not be subjected to the same radiation. Also, of course, the sides of the frame member exposed to the exterior of the building may be required to be colored one color while the sides exposed to the interior of the building are required to be colored in a different color.

By separately coextruding the cap stocks, the one cap stock can be colored to suit the customers choice for the outside color of the building and the other cap stock can be colored to suite the choice of the customer's color for the inside of the building. This choice may involve the different colors on opposite sides of the frame member but also the same color. Moreover, having the two separately coextruded cap stocks, the thicknesses of the cap stocks can be varied so that they are the same or different or, again, the compositions of the cap stocks can be the same or different depending on the customer's requirements.

Where the frame member is to be welded to other frame members, the invention provides for increasing the thickness of the cap stock covering that area so that the cap stock thickness will be such that, on cleaning the weld area, the underlying core will not be exposed which would require painting to cover up.

By extruding the frame members as hollow frame members by the use of the cooling pin 13 which forms an internal hollow chamber running the length of the extrusion, the weight of the frame members formed by the process is reduced without sacrificing required rigidity and the insulation properties of the frame members are enhanced.

While FIG. 1 shows a single cooling pin to produce a single hollow chamber, it will be understood that additional cooling pins to produce additional hollow chambers running the length of the extrusions can be provided.

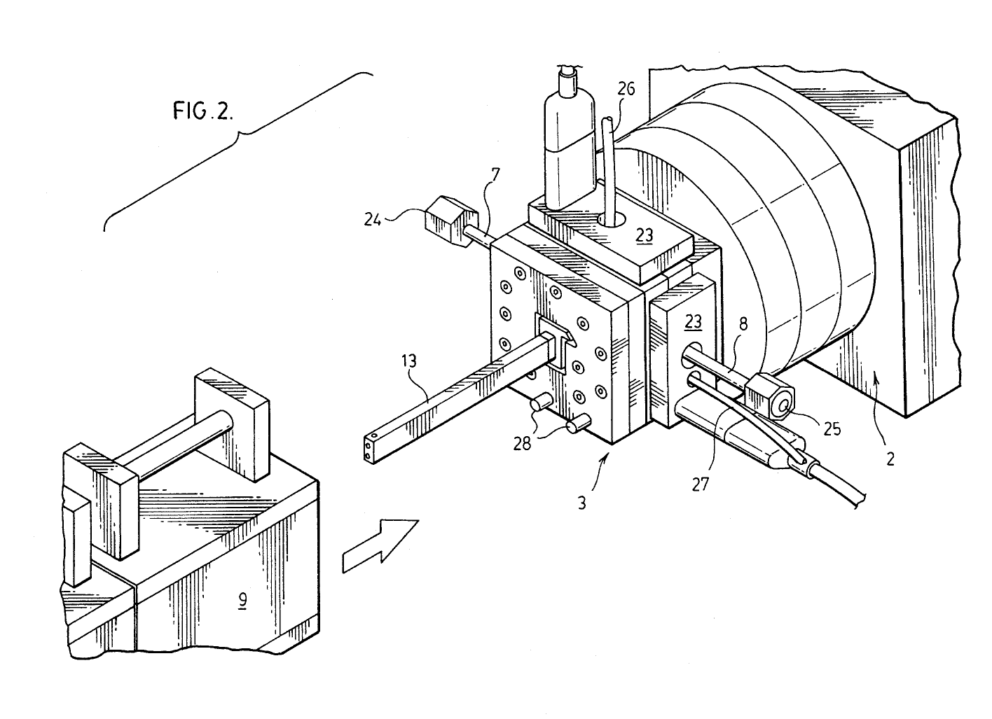

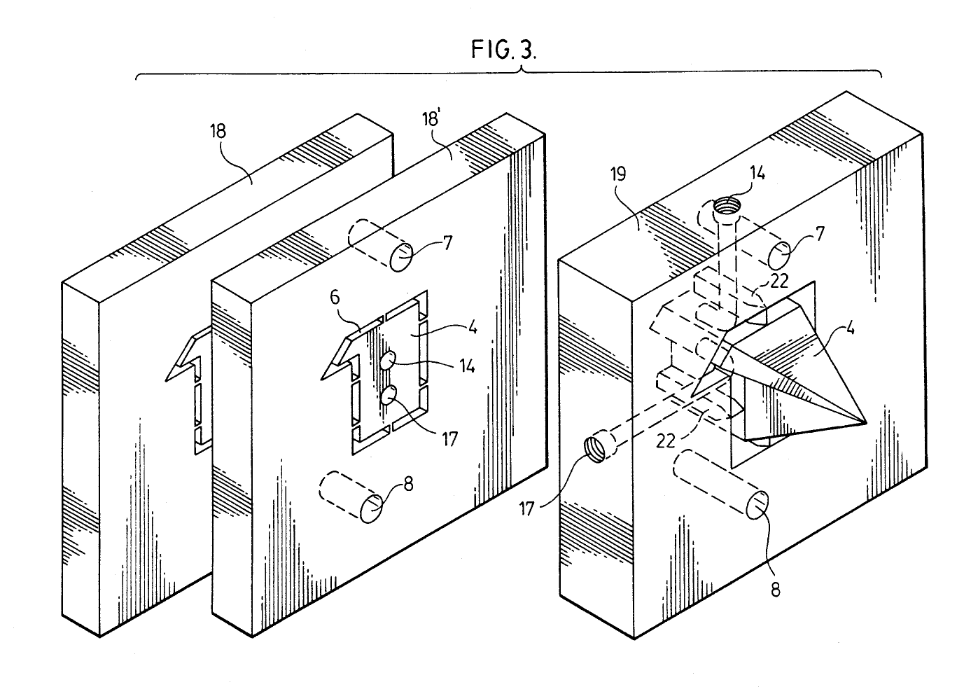

With reference to FIG. 2, it will be seen that the die 3 comprises four separate sections in the form of a front plate 18, a front intermediate plate 18′, a spider plate 19, a rear intermediate plate 20 and a back plate 21. The splitter pin 4 is provided with wings 22 by means of which it is mounted in the spider plate 19 as illustrated particularly in FIG. 3.

The die 3 is maintained in heated condition by heaters 23.

Supply of the first cap stock material to the passageway 7 is provided through inlet connection 24 while the supply of the second cap stock material to the passageway 8 is provided through inlet connector 25. The inlet water to the cooling pin water circulating circuit inlet passage 14 is provided through pipe 26 while the return of the water from the outlet passage 16 of the cooling pin circulating circuit is delivered through pipe 27.

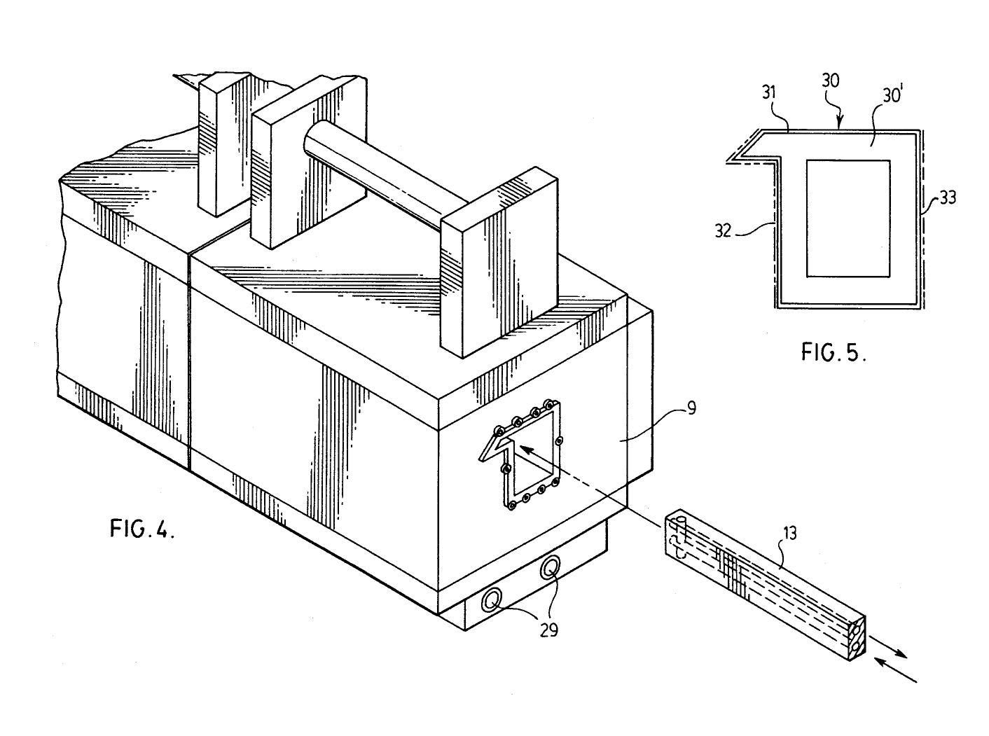

As shown in FIG. 2, the front plate 17 has locating projections 28 which register with the locating receptacles 29 provided on the first calibrating unit 9 as shown in FIG. 4.

The configuration of the die opening 6 along with the configuration of the cooling pin 13 produces the extruded frame member 30 illustrated in FIG. 5 having a foamed hollowed plastic core 30′ with a smooth hard enveloping protective skin 31 portions of which will bear the first cap stock 32 delivered through passageway 7 and portions of which will bear the second cap stock 33 delivered through passageway 8.

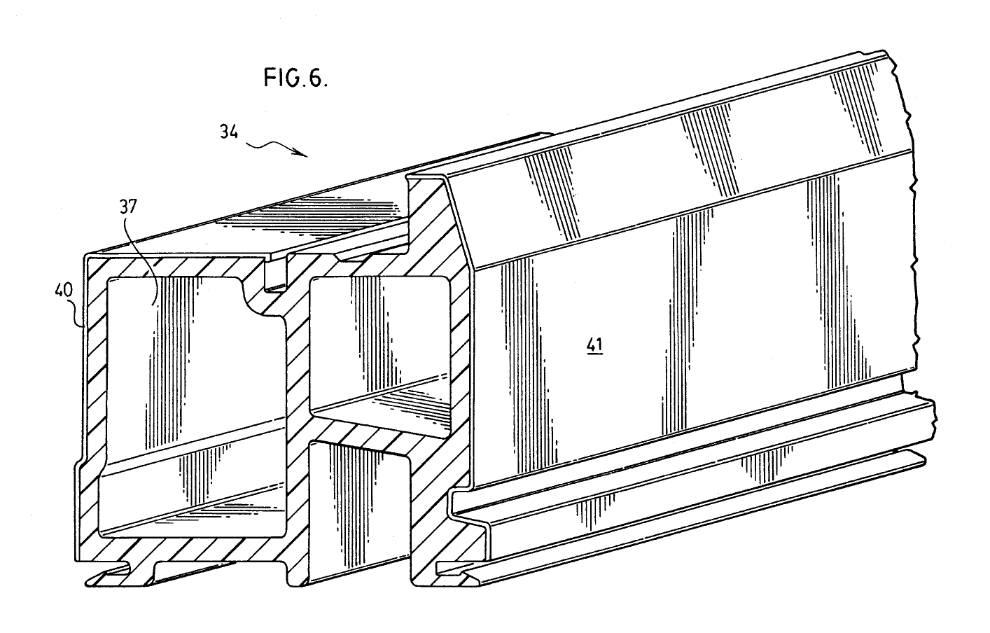

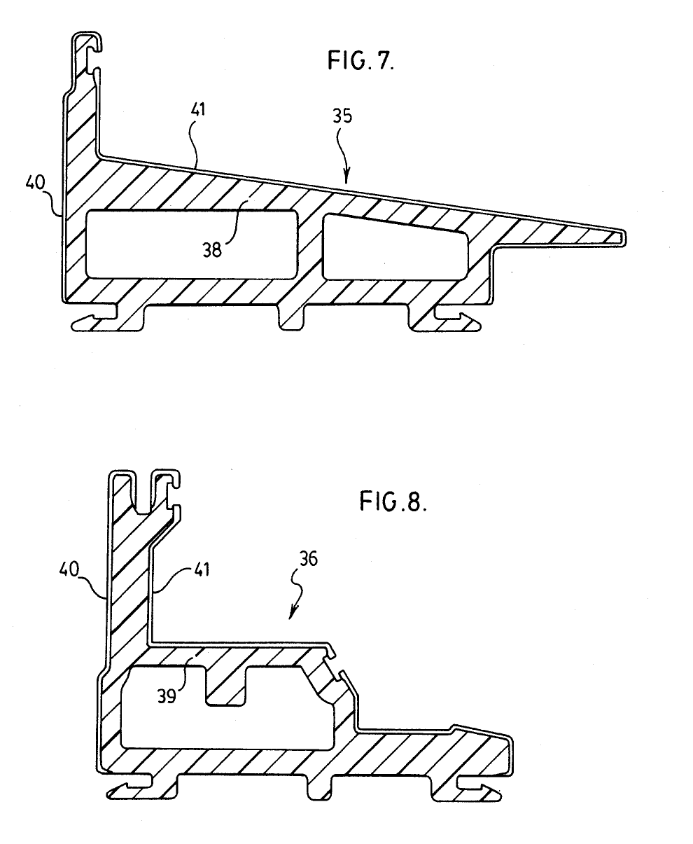

While the tooling disclosed produces the simple frame profile of FIG. 5, it will be understood that the frame profiles may take much more complicated forms as illustrated by the frames 34, 35 and 36 shown in FIGS. 6, 7 and 8 respectively wherein in each case the foamed cores indicated at 37, 38 and 39 respectively are hollowed and the exterior surfaces have selected areas covered by one selected cap stock 40 while other selected areas are covered by a second separately applied cap stock 41.

It will be understood that other variations may be made in the frame members according to the invention and, for instance, in the case of a very small cross section picture frame, the die could omit the cooling pin with the result that the frame member would have a foamed solid core with hard smooth protective enveloping skin having selected areas bearing separately coextruded cap stocks as desired.

It will be understood that these and other variations may be made without departing from the scope of the appended claims.

1. A method of extruding a rigid frame member comprising:
extruding a foamed plastic core with an enveloping skin through a die;
coextruding from a first passageway through the die a first plastic coating to a first selected surface area of the skin of the plastic core; and
coextruding from a second passageway through the die a second plastic coating to a second selected surface area of the skin of the plastic core, wherein the second passageway feeds the second plastic coating separately from the first passageway feeding the first plastic coating.

2. The method of claim 1, wherein the first and second plastic coatings are the same material.

3. The method of claim 1, wherein the first and second plastic coatings are different materials.

4. The method of claim 1, wherein the first and second plastic coatings are different colors.

5. The method of claim 1, further comprising drawing the plastic core over a cooling pin.

6. The method of claim 5, further comprising conforming the first and second plastic coatings to a wall of a calibrator passageway to provide details of a predetermined frame profile.

7. The method of claim 1, further comprising conforming the first and second plastic coatings to a wall of a calibrator passageway to provide details of a predetermined frame profile.

8. The method of claim 1, wherein the first and second plastic coatings have a different thickness.

9. The method of claim 2, wherein the first and second plastic coatings have a different thickness.

10. The method of claim 3, wherein the first and second plastic coatings have a different thickness.

11. The method of claim 5, further comprising delivering cooling water to the cooling pin through the die and returning the water from the pin through the die.

12. The method of claim 11, further comprising conforming the first and second plastic coatings to a wall of a calibrator passageway to provide details of a predetermined frame profile.

13. The method of claim 1, wherein the foamed plastic core comprises foamable polyvinyl chloride and at least one coating includes polyvinyl chloride.

14. The method of claim 13, wherein the at least one coating including polyvinyl chloride further includes an acrylic.

15. The method of claim 1, wherein at least one coating includes an ultraviolet stabilizer.

16. The method of claim 4, further comprising coloring the first plastic coating a preselected outside color and coloring the second plastic coating a preselected inside color for a predetermined building.
